(19) United States
(12) Patent Application Publication
(10) Pub. No.: US 2015/0249769 A1
(43) Pub. Date: Sep. 3, 2015

(54) IMAGE FORMING APPARATUS, METHOD FOR CONTROLLING IMAGE FORMING APPARATUS, AND STORAGE MEDIUM

(71) Applicant: CANON KABUSHIKI KAISHA, Tokyo (JP)

(72) Inventor: Hideo Asahara, Yokohama-shi (JP)

(21) Appl. No.: 14/634,497

(22) Filed: Feb. 27, 2015

(30) Foreign Application Priority Data
Mar. 3, 2014 (JP) 2014-040075
Feb. 5, 2015 (JP) 2015-020873

(51) Int. Cl. H04N 1/00

(52) U.S. Cl. CPC H04N 1/00962; H04N 1/00941; H04N 1/00925; H04N 2201/0094

(57) ABSTRACT

In an image forming apparatus of a new model, a setting value management unit manages a plurality of setting values including setting values classified into a first category for an old model, by classifying the plurality of setting values into a second category for the new model. Further, an application management unit manages the setting values classified into the first category so that only import is supported. When an instruction for export processing is input, an export management unit determines setting values obtained by excluding setting values of which only import is supported by the application management unit from setting values specified by the instruction, as setting values to be subjected to export processing.

### BACKGROUND OF THE INVENTION

1. Field of the Invention

The present invention relates to the management of setting values of applications which can be installed in an image forming apparatus.

2. Description of the Related Art

Conventionally, there has been an image forming apparatus in which applications can be installed. Such applications are used to add functions, which are not originally provided in the image forming apparatus, to produce added values. Each of these applications has setting values for changing its behavior, and has a mechanism for the application itself to manage the setting values.

Further, it is common that an image forming apparatus is provided with setting value import and export functions to efficiently manage setting values of a plurality of image forming apparatuses. In setting value import processing, to prevent incompatible setting values from being imported, depending on the model or the option of the image forming apparatus, each application itself may be provided with import and export functions. In the above-described mechanism, when the import and export functions of the application are called from the setting value import and export functions, respectively, settings of each application are imported and exported. Although, in the above description, applications which can be additionally installed afterwards in the image forming apparatus are assumed, the form of embodiment is not limited thereto. For example, the above description also applies to the functions originally built in the image forming apparatus.

An application may be given different identifiers and managed as different applications depending on the difference in model and generation between image forming apparatuses although the application provides the same function. Generally, transfer of setting values through the import and export functions is performed between applications having an identical identifier. Japanese Patent Application Laid-Open No. 2013-22872 discusses a technique for enabling flexible data transfer even between applications having different identifiers for uniquely identifying the applications. Japanese Patent Application Laid-Open No. 2013-22872 discusses a method for importing into an image forming apparatus a definition file including a list of identifiers of applications which can use a setting value file, together with the setting value file, and taking over the same setting values between applications having different identifiers, by using the list of identifiers included in the definition file.

However, in the technique discussed in Japanese Patent Application Laid-Open No. 2013-22872, a vendor needs to pregenerate the above-described definition file. Further, a user needs to preacquire the above-described definition file generated by the vendor. Further, if the above-described definition file has not been generated by the vendor, it may become necessary for the user to request the vendor to generate the above-described definition file or generate the above-described definition file by himself or herself. As described above, the technique discussed in the Japanese Patent Application Laid-Open No. 2013-22872 bothers the user to transfer setting values, and is complicated and not user-friendly.

Further, the same setting values may be classified into different categories depending on the integration and abolishment of applications, functions, or setting values. For example, a new model may manage setting values based on categories for the new model different from categories for an old model for classifying setting values for the old model. In such a case, the new model may be able to import and use the setting values classified into the categories for the old model. However, the old model may not be able to use the setting values classified into the categories for the new model even when these setting values are imported. The technique discussed in Japanese Patent Application Laid-Open No. 2013-22872 is used to transfer the setting value file between the applications included in the list, and therefore does not take above-described case into consideration at all.

Further, the user may want to know in advance information about which setting values are importable and exportable to/from an image forming apparatus. However, the conventional technique has not taken a function of inquiring such information into consideration.

### SUMMARY OF THE INVENTION

The present invention is directed to a method for enabling, even when setting values of an image forming apparatus are integrated and abolished, easily taking over setting values before and after the integration and abolishment without bothering a user.

According to an aspect of the present invention, an image forming apparatus that manages setting values by using a second category different from a first category for classifying a plurality of setting values of image forming apparatuses of different models includes a management unit configured to manage a plurality of setting values including setting values classified into the first category, by classifying the plurality of setting values into the second category, and a first control unit configured to control import processing on the setting values classified into the first category. When an instruction for setting value export processing is input, the management unit determines setting values obtained by excluding setting values to be subjected to the import processing by the first control unit from setting values specified by the instruction, as setting values to be subjected to export processing.

Further features of the present invention will become apparent from the following description of exemplary embodiments with reference to the attached drawings.

### BRIEF DESCRIPTION OF THE DRAWINGS

FIG. 1 illustrates an example of a network system including image forming apparatuses according to an exemplary embodiment of the present invention.

FIG. 2 illustrates a hardware configuration of the image forming apparatus.

FIG. 3 illustrates a software configuration of the image forming apparatus.

FIGS. 4A, 4B, and 4C each illustrate an example of information stored and managed by an application management unit.

FIGS. 5A, 5B, and 5C each illustrate an example of export data.

FIG. 6 is a flowchart illustrating an example of processing for registering information of setting values.

FIG. 7 is a flowchart illustrating an example of processing for exporting setting values.

FIG. 8 is a flowchart illustrating an example of processing for importing setting values.

FIG. 9 is a flowchart illustrating an example of processing for acquiring information of importable and exportable setting values.

### DESCRIPTION OF THE EMBODIMENTS

Various exemplary embodiments, features, and aspects of the invention will be described in detail below with reference to the drawings.

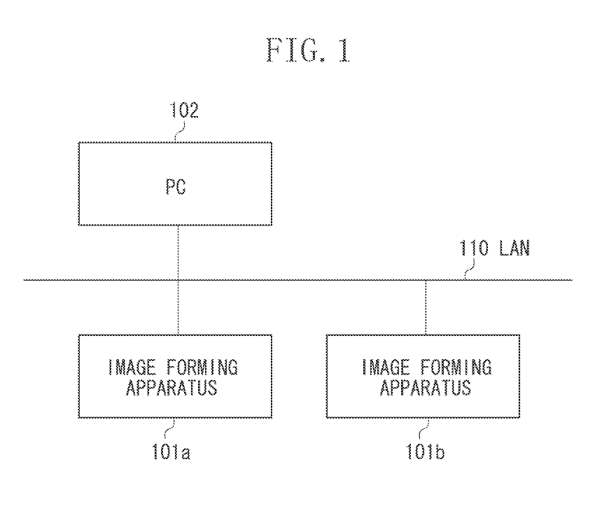

First of all, terms will be defined. “User” refers to a person who uses functions of image forming apparatuses 101a and 101b illustrated in FIG. 1. Hereinafter, any one of the image forming apparatuses 101a and 101b is referred to as an image forming apparatus 101. “Settings” refer to data for changing the behavior of the image forming apparatus 101. The settings are stored by a setting value management unit 301 (described below). Software for implementing each function of the image forming apparatus 101 references the settings as required during operation. “Import” refers to collectively capturing the settings (all settings or settings in predetermined units) of the image forming apparatus 101 into the image forming apparatus 101. “Import data” refers to data to be imported. “Export” refers to collectively transferring the settings (all settings or settings in predetermined units) of the image forming apparatus 101 to the outside of the image forming apparatus 101. “Export data” refers to data exported. Export data is equivalent to import data, and called in different ways depending on the viewpoint of description.

The following situations are assumed in the present exemplary embodiment. There are two different models: the old model and the new model. Applications A and B are installed in the old model. The applications A and B provide functions A and B, respectively. The application A manages authentication settings for the function A. The application B manages authentication settings for the function B. In the new model, the functions A and B are integrated into an application C. In the new model, the authentication settings for the function A and the authentication settings for the function B are integrated as integrated authentication settings. More specifically, the integrated authentication settings include a plurality of settings including the authentication settings for the function A and the authentication settings for the function B. The integrated authentication settings are managed by the application C. An exemplary embodiment will be described below on the premise of the above description.

FIG. 1 illustrates an example of a configuration of a network system including image forming apparatuses 101a and 101b according to an exemplary embodiment of the present invention.

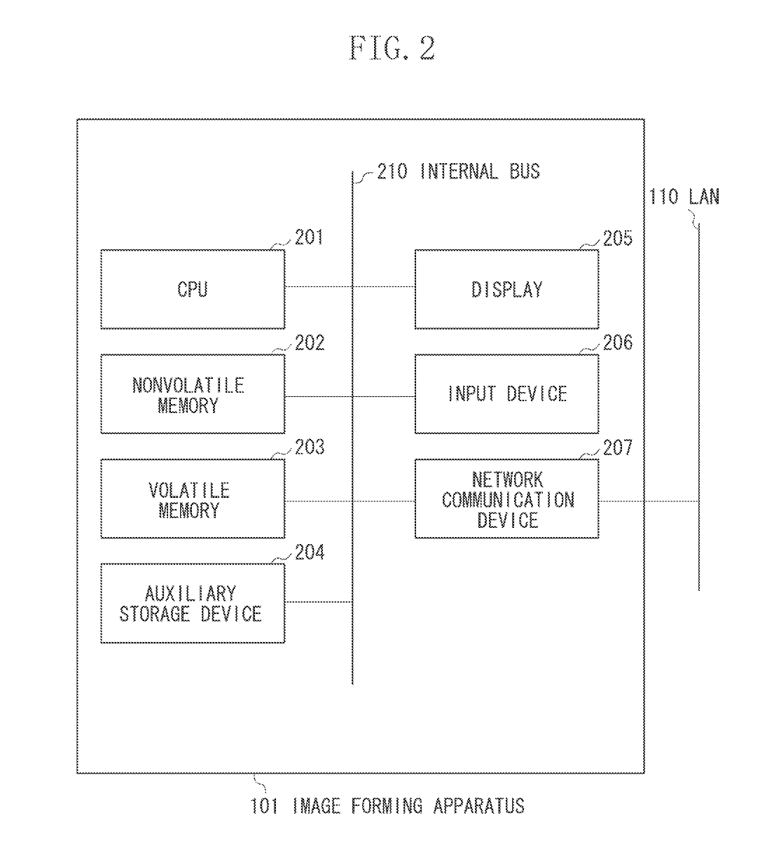

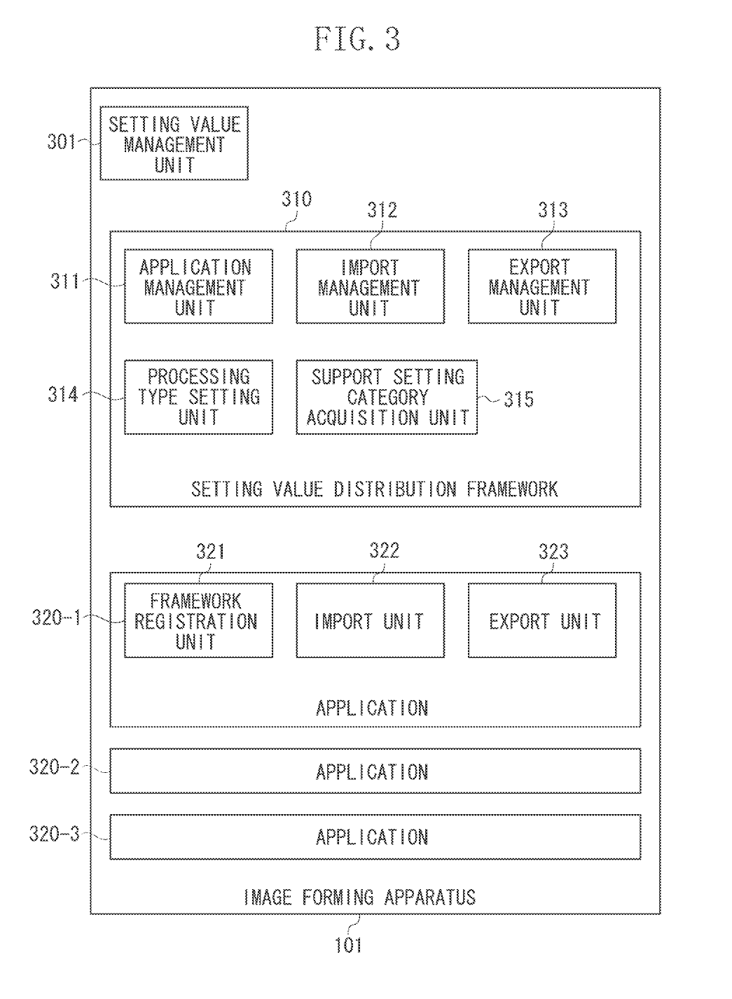

The image forming apparatus 101, typified by a multifunction peripheral, has a function of forming an image. The image forming apparatus 101a and the image forming apparatus 101b similarly refer to the image forming apparatus 101. However, the image forming apparatus 101a refers to the old model, and the image forming apparatus 101b refers to the new model. Via a local area network (LAN) 110, the image forming apparatus 101 is able to communicate with other information apparatuses (for example, a personal computer (PC) 102) connected to the LAN 110. Functions of the image forming apparatus 101 will be described in detail below with reference to FIGS. 2 and 3.

The PC 102 is an ordinary personal computer and is provided with a function of network communication and a web browser. The PC 102 is able to communicate with other information apparatuses connected to the LAN 110. The LAN 110 is a network for enabling digital communication. The image forming apparatus 101 and the PC 102 are connected to the LAN 110 to enable them to communicate with each other.

FIG. 2 is a block diagram illustrating a hardware configuration of the image forming apparatus 101.

A central processing unit (CPU) 201 executes a relevant program, and controls various processing. A nonvolatile memory 202 includes a read only memory (ROM) storing programs and data required in the early stage of the activation processing of the image forming apparatus 101. A volatile memory 203 includes a random access memory (RAM) and is used as an area for temporarily storing programs and data.

An auxiliary storage device 204 includes a mass storage device, such as a hard disk and a RAM drive, for storing large-volume data, executable program codes, and setting values of the image forming apparatus 101. The auxiliary storage device 204 stores data which needs to be stored for a longer time period than data in the volatile memory 203. The auxiliary storage device 204 is a non-volatile storage device, and therefore is able to retain data even after the power of the image forming apparatus 101 is turned off.

A display 205 is a display device for providing information to the user. An input device 206 receives a selection instruction from the user and transmits the instruction to a program via an internal bus 210. The input device 206 includes, for example, hard keys, and a touch panel provided on the surface of the display 205.

A network communication device 207 communicates with other information processing apparatuses via the LAN 110. The internal bus 210 is a communication bus for connecting the hardware units 201 to 207 to enable them to communicate with each other within the above-described image forming apparatus 101.

FIG. 3 is a block diagram illustrating a software configuration of the image forming apparatus 101.

Each software module (hereinafter referred to as software unit) illustrated in FIG. 3 is implemented when the CPU 201 executes a relevant program stored in the nonvolatile memory 202 or the auxiliary storage device 204 in the image forming apparatus 101. Various information used to execute each software unit is stored in the volatile memory 203 or the auxiliary storage device 204, and can be exchanged between the software units. Each software unit communicates with information apparatuses on the network by using the network communication device 207 of the image forming apparatus 101.

Each software unit will be described below.

The setting value management unit 301 stores settings of the image forming apparatus 101. The setting value management unit 301 stores the settings in the auxiliary storage device 204 and refers to them as required. Although, in the present exemplary embodiment, the setting value management unit 301 also manages setting values managed by an application, the setting values may be managed differently. For example, the application itself may store the setting values in a file by using a unique method.

A setting value distribution framework 310 coordinates import and export of setting values, and provides a function of coordinating import and export functions of an application 320.

Functions provided by the setting value distribution framework 310 will be described below.

An application management unit 311 manages information of import and export target setting values based on information registered by the application 320 via a framework registration unit 321 (described below).

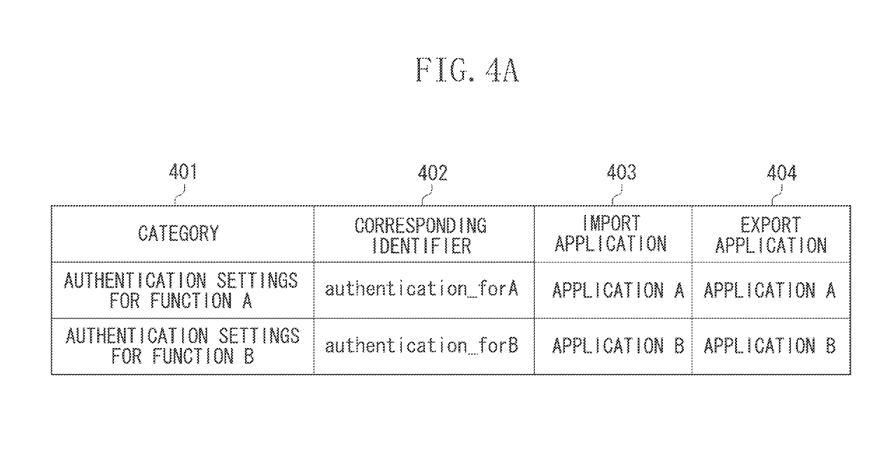

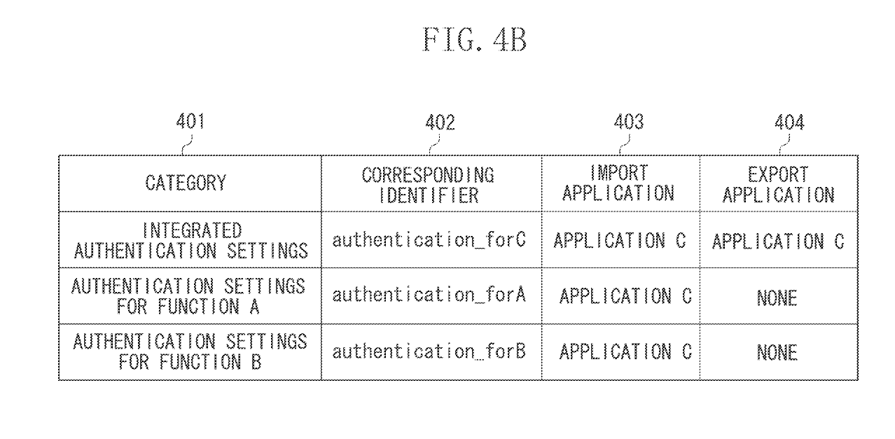

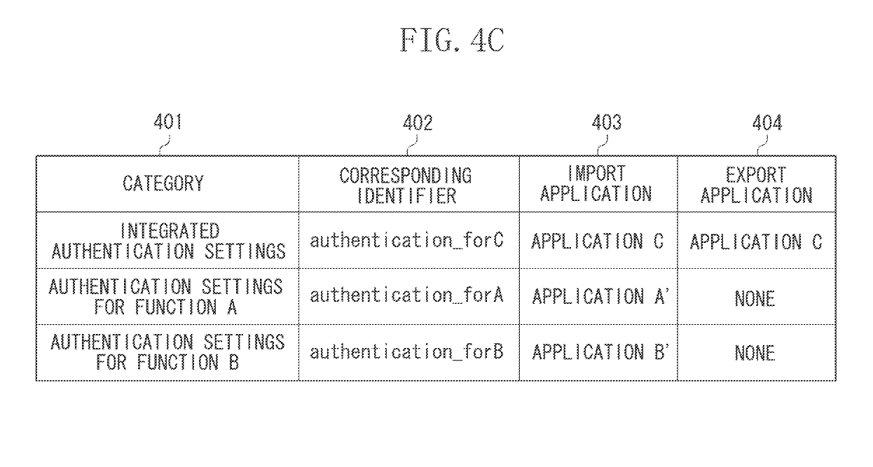

FIGS. 4A, 4B, and 4C each illustrate an example of the information stored and managed by the application management unit 311.

FIG. 4A corresponds to information managed by the application management unit 311 of the image forming apparatus 101a (i.e., the old model). FIG. 4B corresponds to information managed by the application management unit 311 of the image forming apparatus 101b (i.e., the new model).

Referring to FIGS. 4A, 4B, and 4C, a category 401 indicates units of importable and exportable setting values when viewed from the user of the image forming apparatus 101. The example illustrated in FIG. 4A indicates that import and export target setting values can be selected based on the units “Authentication Settings for Function A” and “Authentication Settings for Function B.” On the other hand, the example illustrated in FIG. 4B indicates that import and export target setting values can be selected based on the units “Integrated Authentication Settings”, “Authentication Settings for Function A”, and “Authentication Settings for Function B.”

A corresponding identifier 402 indicates an identifier of the setting values corresponding to the category 401. The example illustrated in FIG. 4A indicates that a setting value identifier “authentication_forA” is associated with the category “Authentication Settings for Function A.” At least one corresponding identifier 402 is preferably assigned to each category. For example, two corresponding identifiers “authentication_forA” and “authentication_forA2” may be assigned to the category “Authentication Settings for Function A”.

An import application 403 indicates information about an application of which import processing should be performed in association with the category 401. The example illustrated in FIG. 4A indicates that import processing of “Application A” is to be called in association with the category “Authentication Settings for Function A.”

To actually call import processing of the application 320 from an import management unit 312 (described below), information about a program, such as a class name and a method name, is required. The present exemplary embodiment assumes an environment in which import processing can be called when the application 320 is identified, on the premise that a fixed class name and a fixed method name are predetermined.

Although, in the present exemplary embodiment, information for identifying the application 320 is stored in the import application 403 to perform import processing corresponding to the category 401, other configurations are possible. For example, a class name and a method name for calling the import processing corresponding to the category 401 may be stored in the import application 403. In this case, information like “com.xxx.appa.ImpExp#import( )” may be stored in the import application 403. Alternatively, a function pointer for calling import processing may be stored in the import application 403. In this case, address information such as “0x80123456” is registered in the import application 403.

In an example of the import application 403 illustrated in FIG. 4A, one application is stored for each category. However, as is the case with an export application 404 illustrated in FIG. 4B, application information may be unregistered (none) or a plurality of applications may be stored as the import application 403. The fact that application information is unregistered as the import application 403 means that the relevant category is not an importable category. The fact that a plurality of applications is registered as the import application 403 means that settings for the relevant category are to be shared and imported by a plurality of applications.

The export application 404 indicates information about an application of which export processing should be performed in association with the category 401. The example illustrated in FIG. 4A indicates that export processing of “Application A” is to be called in association with the category “Authentication Settings for Function A.” The export application 404 differs from the import application 403 only in the data transfer direction (import or export), and the description thereof will be omitted. The example illustrated in FIG. 4C will be described below.

FIG. 3 will be described again below.

The import management unit 312 imports setting values. Upon detection of an import instruction via the above-described input device 206 or the network communication device 207, the import management unit 312 acquires import data according to the contents of the import instruction. Then, the import management unit 312 calls processing of the corresponding import application 403 by referring to the category 401 of setting values included in the acquired import data.

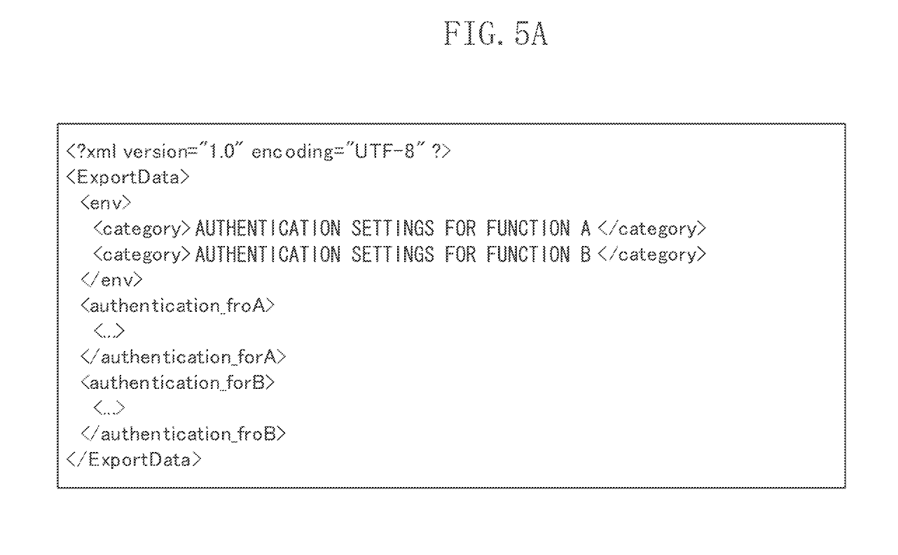

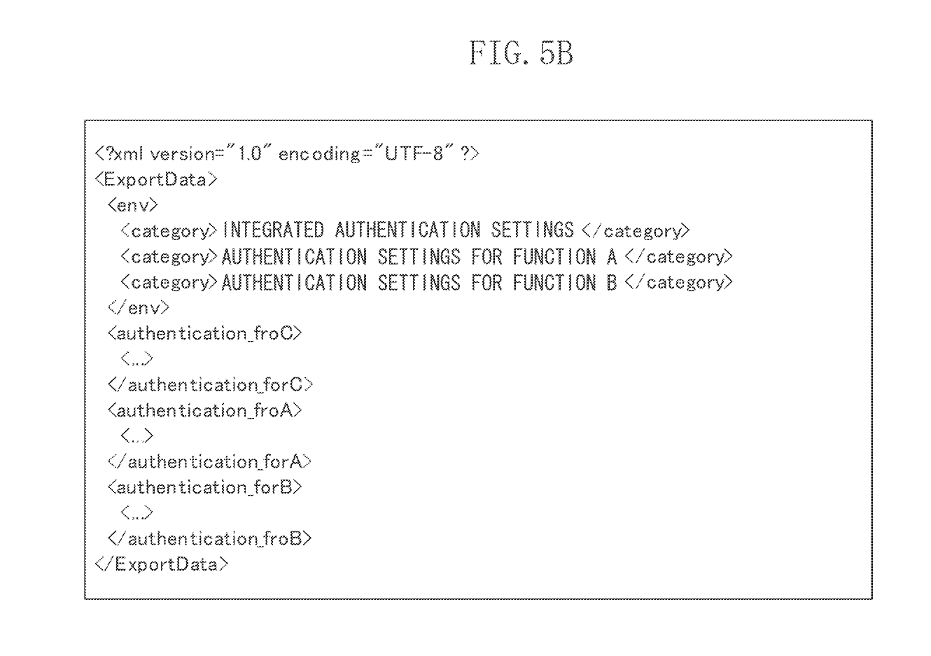

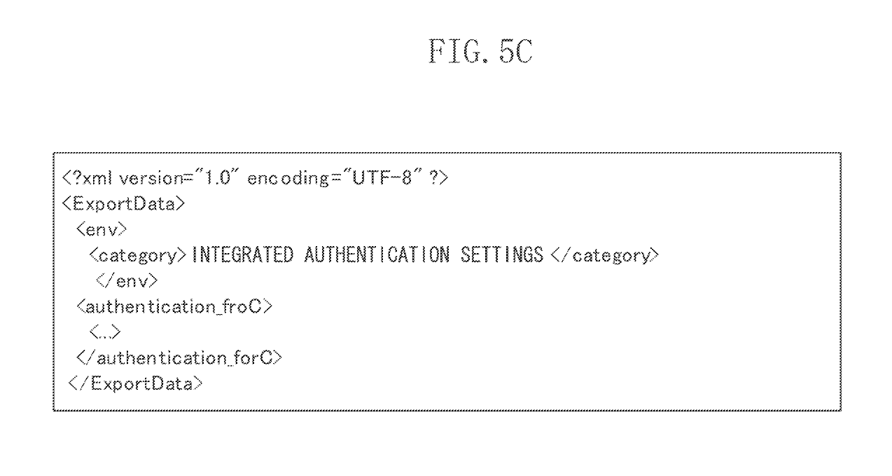

FIGS. 5A, 5B, and 5C each illustrate an example of export data.

Since export data is subjected to import processing, the export data will be described as import data. Although, in the present exemplary embodiment, import data is expressed in the XML format, other formats may be used.

FIG. 5A corresponds to data exported from the image forming apparatus 101a (i.e., the old model). FIGS. 5B and 5C correspond to data exported from the image forming apparatus 101b (i.e., the new model). Export data will be described below with reference to FIG. 5A.

The <env> tag registers information about the entire import data. The <category> tag stores category information (corresponding to the category 401) of setting values included in the import data. The example illustrated in FIG. 5A indicates that the categories “Authentication Settings for Function A” and “Authentication Settings for Function B” are included in the import data. The entity of the category “Authentication Settings for Function A” is described in the <authentication_forA> tag which is the corresponding identifier 402 of the category “Authentication Settings for Function A.” The entity does not relate to the present invention, and the detailed description thereof will be omitted. Similarly, the entity of the category “Authentication Settings for Function B” is described in the <authentication_forB> tag which is the corresponding identifier 402 of the category “Authentication Settings for Function B.”

FIG. 3 will be described again below.

An export management unit 313 exports setting values. Upon detection of an export instruction via the above-described input device 206 or the network communication device 207, the export management unit 313 calls processing of the corresponding export application 404 by referring to the category 401 of requested settings according to the contents of the export instruction. Export data has been described above as import data with reference to FIG. 5A, and the description thereof will be omitted.

Based on setting value information registered from the framework registration unit 321 of the application 320 (described below), a processing type setting unit 314 determines whether the application 320 supports import of the setting values or export of the setting values, and sets the result of the determination to the application management unit 311. For example, when setting value information is registered to the setting value distribution framework 310, together with information indicating that the application 320 supports import, the processing type setting unit 314 registers the application 320 only as the import application 403. When setting value information is registered to the setting value distribution framework 310, together with information indicating that the application 320 supports import and export, the processing type setting unit 314 registers the application 320 as both the import application 403 and the export application 404.

A support setting category acquisition unit 315 provides a function of referring to the category 401 of importable and exportable setting values, from the outside (for example, the PC 102). The example illustrated in FIG. 4A indicates that the category 401 of importable setting values includes the categories “Authentication Settings for Function A” and “Authentication Settings for Function B”, and that the category 401 of exportable setting values also includes the categories “Authentication Settings for Function A” and “Authentication Settings for Function B.” On the other hand, the example illustrated in FIG. 4B indicates that the category 401 of importable setting values includes the categories “Integrated Authentication Settings”, “Authentication Settings for Function A”, and “Authentication Settings for Function B”, and the category 401 of exportable setting values includes only the category “Integrated Authentication Settings.” This completes the description of the functions provided by the setting value distribution framework 310.

The application 320 will be described below.

The application 320 is software for providing specific functions on the image forming apparatus 101. A plurality of the applications 320 can be installed in the image forming apparatus 101. For example, in the example illustrated in FIG. 3, three different applications 320-1, 320-2, and 320-3 are installed in the image forming apparatus 101. Hereinafter, any one of the applications 320-1, 320-2, and 320-3 is referred to as the application 320. The detailed description of the configuration of the application 320 is made for the application 320-1, and omitted for the applications 320-2 and 320-3.

Functions provided by the application 320 will be described below.

The framework registration unit 321 registers to the setting value distribution framework 310 information of setting values managed by the application 320. More specifically, the framework registration unit 321 registers to the application management unit 311 four pieces of information “category”, “corresponding identifier”, “whether to support import”, and “whether to support export”, as illustrated by the category 401, the corresponding identifier 402, the import application 403, and the export application 404, respectively, in FIGS. 4A, 4B, and 4C.

The application A illustrated in FIG. 4A will be described below. The framework registration unit 321 registers to the application management unit 311 information indicating that the setting value identifier “authentication forA” (the corresponding identifier 402) belongs to the category “Authentication Settings for Function A” (the category 401). For setting values of the category “Authentication Settings for Function A”, the framework registration unit 321 further registers in the application management unit 311 information indicating that the application A (the import application 403) supports import and information indicating that the application A (the export application 404) supports export. As a result, information like “Authentication Settings for Function A” illustrated in FIG. 4A is registered to the application management unit 311. This also applies to the application B. Information like “Authentication Settings for Function B” illustrated in FIG. 4A is registered to the application management unit 311.

The application C illustrated in FIG. 4B will be described below. The application C supports the category “Integrated Authentication Settings” which integrates the categories “Authentication Settings for Function A” and “Authentication Settings for Function B.” Therefore, the framework registration unit 321 registers to the application management unit 311 information indicating that the setting value identifier “authentication_forC” (the corresponding identifier 402) belongs to the category “Integrated Authentication Settings” (the category 401). For setting values of the category “Authentication Settings for Function C”, the framework registration unit 321 further registers to the application management unit 311 information indicating that the application C (the import application 403) supports import and information indicating that the application C (the export application 404) supports export.

To enable the categories “Authentication Settings for Function A” and “Authentication Settings for Function B” to be taken over from export data of the old model, the application C also requests the registration of the following information. More specifically, the framework registration unit 321 associates the identifier “authentication_forA” with the category “Authentication Settings for Function A”, and registers to the application management unit 311 information indicating that the application C supports only import. The framework registration unit 321 further associates the identifier “authentication_forB” with the category “Authentication Settings for Function B”, and registers to the application management unit 311 information indicating that the application C supports only import. As a result, information as illustrated in FIG. 4B is registered to the application management unit 311.

The following describes an example in which import of the categories “Authentication Settings for Function A” and “Authentication Settings for Function B” in the image forming apparatus 101b of the new model is supported not by the application C but by an application A′ and an application B′. In the case of this example, the application A′ and the application B′ are applications (hereinafter referred to as compatible applications) for performing processing for importing the setting values classified into the categories for the old model. These compatible applications can be installed in the image forming apparatus 101b of the new model. For example, the applications 320-2 and 320-3 (illustrated in FIG. 3) are assumed to be the above-described compatible applications in the image forming apparatus 101b of the new model.

These compatible applications support only import of setting values and do not support export thereof. Therefore, each of these compatible applications includes the framework registration unit 321 and an import unit 322 and does not include an export unit 323. Setting values imported from these compatible applications are managed as setting values which can only be imported by the application management unit 311.

The framework registration unit 321 of the application A′ associates the corresponding identifier “authentication forA” with the category “Authentication Settings for Function A”, and registers to the application management unit 311 information indicating that the application A′ supports import and does not support export. As a result, information like “Authentication Settings for Function A” illustrated in FIG. 4C is registered to the application management unit 311. Similarly, in response to a registration request from the application B′, the framework registration unit 321 associates the corresponding identifier “authentication_forB” with the category “Authentication Settings for Function B”, and registers to the application management unit 311 information indicating that the application B′ supports import and does not support export. As a result, information like “Authentication Settings for Function B” illustrated in FIG. 4C is registered to the application management unit 311.

The import unit 322 will be described below.

The import unit 322 performs processing for importing setting values. More specifically, the import unit 322 registers to the above-described setting value management unit 301 import data transmitted from the import management unit 312. The present exemplary embodiment assumes that the categories “Authentication Settings for Function A” and “Authentication Settings for Function B” of the old model are taken over to the new model. In the image forming apparatus 101b of the new model, for example, the application C performs import processing for the categories “Authentication Settings for Function A” and “Authentication Settings for Function B.” The following describes a case where, for example, the category “Integrated Authentication Settings” of the new model is imported to the new model.

FIG. 5B illustrates an example of export data in a case where export processing is performed by the image forming apparatus 101b of the new model with the category “Integrated Authentication Settings” specified.

In the example illustrated in FIG. 5B, the export data includes not only the <category> tag for the category “Integrated Authentication Settings” but also the <category> tags for the categories “Authentication Settings for Function A” and “Authentication Settings for Function B.” The <category> tags for the categories “Authentication Settings for Function A” and “Authentication Settings for Function B” are included for compatibility with the old model. Therefore, as illustrated in FIG. 5C, when export processing is performed by the image forming apparatus 101b with the category “Integrated Authentication Settings” specified, the export processing may be configured so that the <category> tag includes only the category “Integrated Authentication Settings” and does not include the categories “Authentication Settings for Function A” and “Authentication Settings for Function B.”

When performing import processing on the import data illustrated in FIG. 5B, the import management unit 312 also calls import processing for the categories “Authentication Settings for Function A” and “Authentication Settings for Function B” (the import unit 322 of the application C in the example illustrated in FIG. 4B). However, since the categories “Authentication Settings for Function A” and “Authentication Settings for Function B” are registered only for compatibility with the old model, it is only necessary to import the category “Integrated Authentication Settings” for export data of the new model. Therefore, when the import unit 322 of the application C is called to perform import processing for the categories “Authentication Settings for Function A” and “Authentication Settings for Function B”, the import unit 322 of the application C performs control in the following way. The import unit 322 of the application C determines whether import of the category “Integrated Authentication Settings” has been performed. When import of the category “Integrated Authentication Settings” is determined to have been performed, the import unit 322 of the application C performs control not to execute import processing for the categories “Authentication Settings for Function A” and “Authentication Settings for Function B.”

A configuration different from the above-described one may be used, in which the above-described application A′ and application B′ are installed in the image forming apparatus 101b, and the application A′ performs import processing for the category “Authentication Settings for Function A” and application B′ performs import processing for the category “Authentication Settings for Function B.” In this configuration, the application C performs import processing for the category “Integrated Authentication Settings” and does not perform import processing for the categories “Authentication Settings for Function A” and “Authentication Settings for Function B.”

In this configuration, when the import unit 322 of the application A′ is called to perform import processing for the category “Authentication Settings for Function A”, the import unit 322 performs control in the following way. The import unit 322 of application A′ determines whether import of the category “Integrated Authentication Settings” has been performed by the import unit 322 of the application C. When import of the category “Integrated Authentication Settings” is determined to have been performed by the import unit 322 of the application C, the import unit 322 of application A′ performs control not to execute import processing for the category “Authentication Settings for Function A.” Similarly, when import of the category “Integrated Authentication Settings” is determined to have been performed, the import unit 322 of the application B′ performs control not to execute import processing for the category “Authentication Settings for Function B.” Whether import of the category “Integrated Authentication Settings” has been performed can be checked by making an inquiry from the application 320 to the import management unit 312 or by providing a notification from the import management unit 312 to the application 320. Further, when the category “Integrated Authentication Settings” is a combination of the categories “Authentication Settings for Function A” and “Authentication Settings for Function B”, compatible applications (the applications A′ and B′) may perform import processing, and the application C may ignore a call.

In any one of the above-described configurations, when an import instruction is issued with a plurality of categories specified, an application is called a plurality of times for import processing for the same setting values duplicated in different categories. In this case, the application side performs control to ignore the second and subsequent calls to avoid duplicated settings. For example, when a call to the application C occurs a plurality of times, the application C ignores the second and subsequent calls. Further, when both a call to the application C and a call to the compatible applications (the applications A′ and B′) occur, the compatible applications or the application C ignore the call.

A configuration different from the above-described configuration will be described below. For example, even when import of the category “Integrated Authentication Settings” has been performed, the import unit 322 may perform import processing for the categories “Authentication Settings for Function A” and “Authentication Settings for Function B.” In this configuration, the import processing results in being performed correctly although the import processing is unnecessary. Alternatively, the import management unit 312 may determine that a category in which only the import application 403 is registered is a category for compatibility, and, in the case of import processing between new models, may not call an import application corresponding to the category for compatibility. In this configuration, it is necessary to embed exported model information of the image forming apparatus 101, for example, in the <env> tag described with reference to FIG. 5A.

The export unit 323 will be described below.

The export unit 323 performs processing for exporting setting values. More specifically, the export unit 323 writes setting values specified by the export management unit 313 to export data. The present exemplary embodiment assumes that the categories “Authentication Settings for Function A” and “Authentication Settings for Function B” of the old model are taken over to the new model.

The following describes a configuration of the image forming apparatus 101b of the new model in which the categories “Authentication Settings for Function A” and “Authentication Settings for Function B” of the old model are assumed to be taken over to the new model, and the category “Integrated Authentication Settings” of the new model is assumed not to be taken over to the old model. When export processing is performed by the image forming apparatus 101b having such a configuration with the category “Integrated Authentication Settings” specified, the export data is as follows. In this case, the export data includes only the <category> tag for the category “Integrated Authentication Settings” and does not include the <category> tags for the categories “Authentication Settings for Function A” and “Authentication Settings for Function B.” Further, the export data includes neither the <authentication_forA> tag nor the <authentication_forB> tag. More specifically, the export data is as illustrated in FIG. 5C.

Further, the configuration may be such that the category “Integrated Authentication Settings” of the new model is assumed to be taken over to the old model. The following describes a configuration of the image forming apparatus 101b of the new model in which the categories “Authentication Settings for Function A” and “Authentication Settings for Function B” of the old model are assumed to be taken over to the new model, and the category “Integrated Authentication Settings” of the new model is assumed to be taken over to the old model. When export processing is performed by the image forming apparatus 101b having such a configuration with the category “Integrated Authentication Settings” specified, the export data is as follows. In this case, the export data includes not only the <category> tag for the category “Integrated Authentication Settings” but also the <category> tags for the categories “Authentication Settings for Function A” and “Authentication Settings for Function B.” When the application C exports the category “Integrated Authentication Settings”, the application C also includes the <category> tags for the categories “Authentication Settings for Function A” and “Authentication Settings for Function B” in the export data in consideration of compatibility with the earlier models. Similarly, the application C also includes the <authentication_forA> tag, the <authentication_forB> tag, and the subsequent tags in the export data. More specifically, the export data is as illustrated in FIG. 5B.

Further, the user (for example, an administrator) may select a mode for generating export data with which setting values (integrated on the new model) are not taken over to the old model, as illustrated in FIG. 5C, or a mode for generating export data with which setting values (integrated on the new model) are taken over to the old model, as illustrated in FIG. 5B.

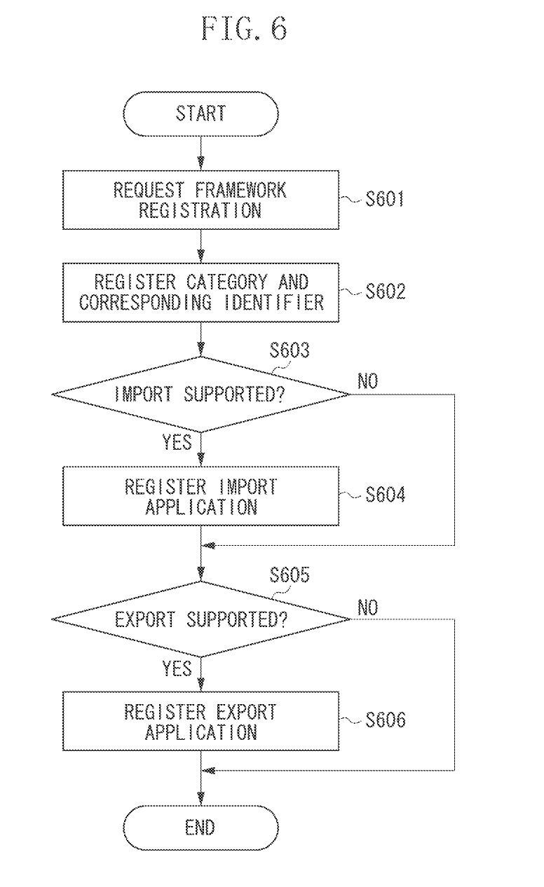

Processing performed by the image forming apparatus 101 will be described below with reference to flowcharts illustrated in FIGS. 6 to 9. Processing illustrated in the flowcharts illustrated in FIGS. 6 to 9 is executed by each software module illustrated in FIG. 3. More specifically, the processing of these flowcharts is implemented when the CPU 201 executes a relevant program stored in the nonvolatile memory 202 or the auxiliary storage device 204 in the image forming apparatus 101.

FIG. 6 is a flowchart illustrating an example of processing performed by the application 320 to register information of setting values to the application management unit 311.

In step S601, the framework registration unit 321 of the application 320 transmits information of setting values to the setting value distribution framework 310, and requests the registration of information of the setting values. The information of setting values transmitted at this point is information indicating “category”, “corresponding identifier”, “whether to support import”, and “whether to support export.” A setting value information registration request from the application 320 will be made, for example, when the application 320 is installed, when the application 320 is upgraded, or according to an instruction of the administrator.

In step S602, according to the above-described registration request, the application management unit 311 of the setting value distribution framework 310 registers information about the category and information about the corresponding identifier, out of the above-described setting value information transmitted from the framework registration unit 321, as the category 401 and the corresponding identifier 402, respectively.

In step S603, based on the setting value information transmitted from the framework registration unit 321 in step S601, the processing type setting unit 314 determines whether the application 320, which has requested the registration in step S601, supports import. When the processing type setting unit 314 determines that the application 320 supports import (YES in step S603), the processing proceeds to step S604. In step S604, the application management unit 311 registers the application 320, which has requested the registration in step S601, as the import application 403 of the category registered in step S602. Then, the processing proceeds to step S605. On the other hand, when the processing type setting unit 314 determines that the application 320 does not support import (NO in step S603), the processing proceeds to step S605.

In step S605, based on the setting value information transmitted from the framework registration unit 321 in step S601, the processing type setting unit 314 determines whether the application 320, which has requested the registration in step S601, supports export. When the processing type setting unit 314 determines that the application 320 supports export (YES in step S605), the processing proceeds to step S606. In step S606, the application management unit 311 registers the application 320, which has requested the registration in step S601, as the export application 404 of the category registered in step S602. Then, the processing exits this flowchart. On the other hand, when the processing type setting unit 314 determines that the application 320 does not support export (NO in step S605), the processing exits this flowchart.

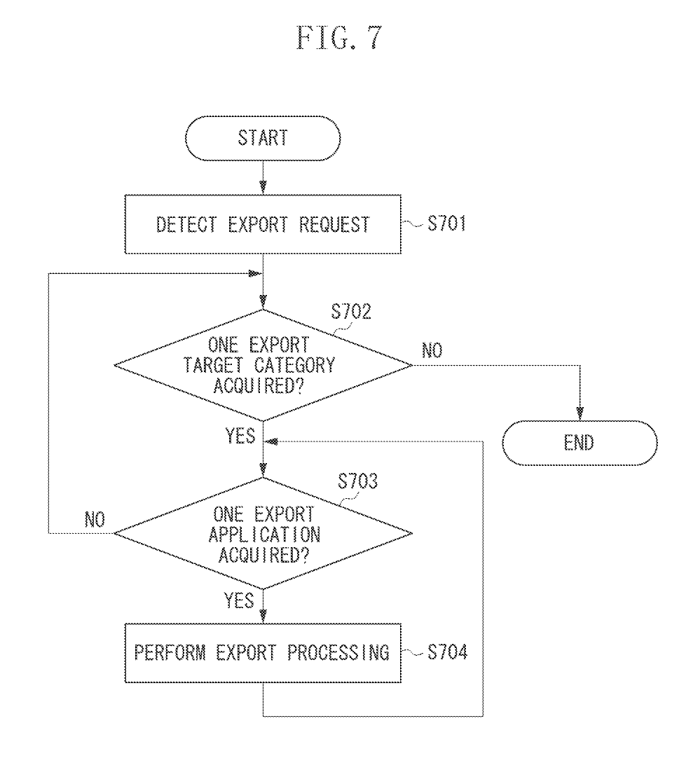

FIG. 7 is a flowchart illustrating processing for exporting setting values.

Upon input of an export request, in step S701, the export management unit 313 of the setting value distribution framework 310 detects the export request. Then, the processing proceeds to step S702. An export request is input, for example, from the input device 206 or an external apparatus such as the PC 102. When issuing an export request, it is necessary to specify the category 401 of export request target setting values and an export destination. For the export request target setting values, categories can be individually specified or collectively specified.

In step S702, the export management unit 313 performs processing for acquiring one unprocessed category of setting values out of the categories of export request target setting values specified by the export request detected in step S701. When one unprocessed category of setting values is determined to have been acquired (YES in step S702), the processing proceeds to step S703.

In step S703, referring to the application management unit 311, the export management unit 313 performs processing for acquiring one unprocessed export application out of the export applications 404 associated with the category 401 of setting values acquired in step S702. When one unprocessed export application is determined to have been acquired (YES in step S703), the processing proceeds to step S704.

In step S704, the export management unit 313 requests the export unit 323 of the export application 404 acquired in step S703 to perform export processing for the category 401 of setting values acquired in step S702. Upon reception of this request, the export unit 323 of the export application 404 performs export processing on the setting values of the requested category. In this export processing, the export unit 323 acquires the setting values of the requested category from the setting value management unit 301, and outputs the acquired setting values to the export destination specified by the above-described export request. Then, the processing returns to step S703. The export management unit 313, which has requested export processing, proceeds to processing for the next export application.

When export processing is completed for all the export applications 404, and any unprocessed export application is determined to have not been acquired (NO in step S703), then in step S702, the export management unit 313 proceeds to processing for the next category of setting values.

When export processing is completed for all the categories 401 of setting values specified by the export request, and any unprocessed category of setting values is determined to have not been acquired (NO in step S702), the processing exits this flowchart.

In the export processing performed by the export unit 323, in step S704, the export unit 323 may output setting values directly to the export destination specified by the export request. Alternatively, the export unit 323 may output setting values to the volatile memory 203, and, when processing is completed for all the categories of setting values, the export management unit 313 may collectively output setting values, output in the volatile memory 203 in step S704, to the export destination specified by the above-described export request.

As described above, upon input of a setting value export processing instruction, the export management unit 313 determines export processing target setting values out of the setting values specified by the export processing instruction, based on the setting value information managed by the application management unit 311. Then, the export unit 323 of the export application 404 for the export processing target setting values performs export processing.

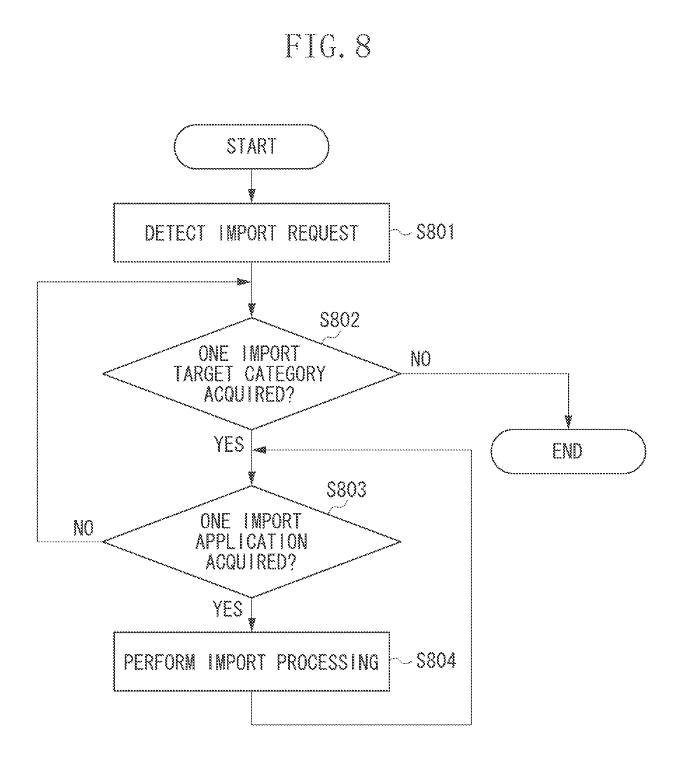

FIG. 8 is a flowchart illustrating processing for importing setting values.

Upon input of an import request, in step S801, the import management unit 312 of the setting value distribution framework 310 detects the import request. Then, the processing proceeds to step S802. An import request is input, for example, from the input device 206 or an external apparatus such as the PC 102. When issuing an import request, it is necessary to specify the category 401 of import request target setting values and an import data file as an import source. For the import request target setting values, categories can be individually or collectively specified.

In step S802, the import management unit 312 performs processing for acquiring one unprocessed category of setting values out of the categories of import request target setting values specified by the import request detected in step S801. When one unprocessed category of setting values is determined to have been acquired (YES in step S802), the processing proceeds to step S803.

In step S803, referring to the application management unit 311, the import management unit 312 performs processing for acquiring one unprocessed import application out of the import applications 403 associated with the category 401 of setting values acquired in step S802. When one unprocessed import application is determined to have been acquired (YES in step S803), the processing proceeds to step S804.

In step S804, the import management unit 312 acquires from the above-described import source the import data of the category 401 of setting values acquired in step S802, and requests the import unit 322 of the import application 403 acquired in step S803 to perform import processing on the acquired import data. Upon reception of this request, the import unit 322 of the import application 403 performs import processing on the setting values of the requested category. In this import processing, the import unit 322 stores the setting values of the requested category in the setting value management unit 301. Then, the processing returns to step S803. The import management unit 312, which has requested import processing, proceeds to processing for the next import application.

When import processing is completed for all the import applications 403, and any unprocessed import application is determined to have not been acquired (NO in step S803), the processing returns to step S802. The import management unit 312 proceeds to processing for the next category.

When import processing is completed for all the categories 401 of setting values specified by the import request, and any unprocessed category of setting values is determined to have not been acquired (NO in step S802), the processing exits this flowchart.

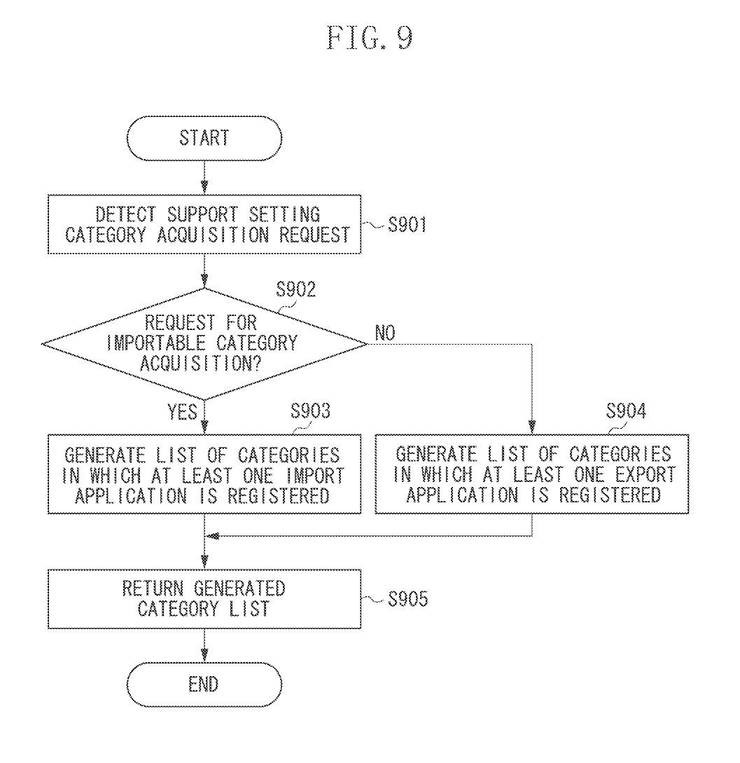

FIG. 9 is a flowchart illustrating an example of processing for acquiring information about importable and exportable setting values.

Upon input of a support setting category acquisition request, in step S901, the support setting category acquisition unit 315 of the setting value distribution framework 310 detects the support setting category acquisition request. Then, the processing proceeds to step S902. A support setting category acquisition request is input, for example, from an external apparatus such as the PC 102. When issuing a support setting category acquisition request, it is necessary to specify whether the input request is a request for import processing or a request for export processing.

In step S902, the support setting category acquisition unit 315 determines whether the support setting category acquisition request detected in step S901 is a request for import processing. When the request is determined to be a request for import processing (YES in step S902), the processing proceeds to step S903. On the other hand, when the request is determined to be not a request for import processing (NO in step S902), the support setting category acquisition unit 315 determines that the request is a request for export processing. Then, the processing proceeds to step S904.

In step S903, referring to the application management unit 311, the support setting category acquisition unit 315 generates a list of categories in which at least one application is registered as the import application 403. Then, the processing proceeds to step S905.

In step S904, referring to the application management unit 311, the support setting category acquisition unit 315 generates a list of categories in which at least one application is registered as the export application 404. More specifically, information of the export application 404 illustrated in FIGS. 4A to 4C is used to generate the list. A category in which an application is unregistered (none) as the export application 404 is not subject to export processing and thus is not included in the list. Then, the processing proceeds to step S905.

In step S905, the support setting category acquisition unit 315 returns the list of categories generated in above-described step S903 or step S904 to a requestor that has issued the support setting category acquisition request detected in step S901.

As described above, according to the present exemplary embodiment, it is possible to import and export setting values without bothering the user of the image forming apparatus 101, even when applications, functions, or setting values are integrated and abolished in the image forming apparatus 101. Further, it is possible to make an inquiry to the image forming apparatus 101 about information of importable and exportable setting values, from an external system such as the PC 102.

More specifically, it is possible, even when setting values of an image forming apparatus are integrated and abolished, to easily take over setting values before and after the integration and abolishment without bothering the user.

The above-described configuration and contents of various data are not limited thereto, and, obviously, various data is composed of diverse configurations and contents according to applications and purposes.

Although one exemplary embodiment has been described above, an exemplary embodiment of the present invention can be realized as a system, an apparatus, a method, a program, or a storage medium. More specifically, an exemplary embodiment of the present invention may be applied to a system including a plurality of apparatuses, or to an apparatus including one device.

Further, any combinations of the above-described exemplary embodiments are also included in the present invention.

According to the above-described exemplary embodiment, it is possible, even when setting values of an image forming apparatus are integrated and abolished, to easily take over setting values before and after the integration and abolishment without bothering the user.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-040075 filed Mar. 3, 2014 and Japanese Patent Application No. 2015-020873 filed Feb. 5, 2015, which are hereby incorporated by reference herein in its entirety.

What is claimed is:

1. An image forming apparatus that manages setting values by using a second category different from a first category for classifying a plurality of setting values of image forming apparatuses of different models, the image forming apparatus comprising:
a management unit configured to manage a plurality of setting values including setting values classified into the first category, by classifying the plurality of setting values into the second category; and
a first control unit configured to control import processing on the setting values classified into the first category,
wherein, when an instruction for setting value export processing is input, the management unit determines setting values obtained by excluding setting values to be subjected to the import processing by the first control unit from setting values specified by the instruction, as setting values to be subjected to export processing.

2. The image forming apparatus according to claim 1, further comprising:
a second control unit configured to control import processing on setting values with the second category specified,
wherein, when the instruction for setting value export processing is input, the management unit determines the setting values to be subjected to the export processing from among the setting values specified by the instruction, without excluding setting values to be subjected to the import processing by the second control unit.

3. The image forming apparatus according to claim 2, wherein, when an instruction for import processing with the first and the second categories specified is input and when both a call to the first control unit and a call to the second control unit occur for import processing related to same setting values, one of the first and the second control units ignores the call.

4. The image forming apparatus according to claim 1, wherein the management unit manages the setting values to be subjected to the import processing by the first control unit, as setting values which can be subjected only to import processing.

5. The image forming apparatus according to claim 1, further comprising:
an acquisition unit configured to acquire information of setting values that the management unit manages as the setting values to be subjected to the export processing.

6. The image forming apparatus according to claim 1, further comprising:
a second control unit configured to control export processing on the setting values that the management unit manages as the setting values to be subjected to the export processing.

7. A method for controlling an image forming apparatus that manages setting values by using a second category different from a first category for classifying a plurality of setting values of image forming apparatuses of different models, the method comprising:
managing a plurality of setting values including setting values classified into the first category, by classifying the plurality of setting values into the second category; and
controlling import processing on the setting values classified into the first category, and determining, when an instruction for setting value export processing is input, setting values obtained by excluding setting values to be subjected to the import processing by the controlling from setting values specified by the instruction, as setting values to be subjected to export processing.

8. A non-transitory computer-readable storage medium storing instructions that, when executed by a computer, cause the computer to perform the method of claim 7.
